(19) United States
(12) Patent Application Publication
(10) Pub. No.: US 2026/0163025 A1
(43) Pub. Date: Jun. 11, 2026

(54) ELECTROCHEMICAL DEVICE

(71) Applicants: Hyundai Motor Company, Seoul (KR); Kia Corporation, Seoul (KR)

(72) Inventors: Kwi Seong Jeong, Hwaseong-si (KR); Ji Soo Kim, Hwaseong-si (KR)

(21) Appl. No.: 19/173,200

(22) Filed: Apr. 8, 2025

(30) Foreign Application Priority Data
Dec. 11, 2024 (KR) 10-2024-0184234

(51) Int. Cl. H01M 8/0276; H01M 8/0263; H01M 8/1004

(52) U.S. Cl. CPC H01M 8/0276; H01M 8/0263; H01M 8/1004

(57) ABSTRACT

An electrochemical device can include a membrane electrode assembly (MEA), a separator stacked on the MEA and including a flow path portion provided to face the MEA, a manifold portion through which a reaction fluid can be introduced or discharged, and a through-hole provided between the flow path portion and the manifold portion to guide the reaction fluid, which has passed through the manifold portion, to the flow path portion, and a sealing part selectively separably stacked on the separator and configured to define a connection channel configured to connect the manifold portion and the flow path portion through the through-hole, and the sealing part includes a first elastic sheet, a second elastic sheet stacked on the first elastic sheet, and a reinforcement sheet having relatively higher rigidity than the first elastic sheet and the second elastic sheet and interposed between the first elastic sheet and the second elastic sheet.

### CROSS-REFERENCE TO RELATED APPLICATIONS

This application claims priority to and the benefit of Korean Patent Application No. 10-2024-0184234 filed in the Korean Intellectual Property Office on Dec. 11, 2024, the entire contents of which are incorporated herein by reference.

### TECHNICAL FIELD

The present disclosure relates to a sealing structure of an electrochemical device.

### BACKGROUND

There is a consistently increasing need for research and development on alternative energy to cope with global warming and depletion of fossil fuel. Hydrogen energy is attracting attention as a practical solution for solving environmental and energy issues.

In particular, because hydrogen has high energy density and properties suitable for application on a grid-scale, hydrogen is in the limelight as a future energy carrier.

A water electrolysis stack, which is a electrochemical device, refers to a device that produces hydrogen and oxygen by electrochemically decomposing water. The water electrolysis stack may be configured by stacking several tens or several hundreds of water electrolysis cells (unit cells) in series.

The water electrolysis cell may include a membrane electrode assembly (MEA), first and second porous transport layers (anode and cathode porous transport layers) respectively disposed at two opposite surfaces of the membrane electrode assembly, and separators (anode and cathode separators).

To configure the water electrolysis stack by stacking the water electrolysis cells, sealability needs to be maintained between the membrane electrode assembly and reaction surfaces of the separators.

To this end, gaskets are provided between the membrane electrode assembly and the reaction surfaces of the separators. That is, the gasket is provided to prevent a reaction fluid (e.g., water), which flows to the reaction surface of the separator, from leaking to the outside of the water electrolysis stack.

The gaskets may be integrally provided, by injection molding, on edge portions of two opposite surfaces of the separator and edge portions of two opposite surfaces of a manifold portion configured to allow the reaction fluid to flow in or out. The flow paths for the reaction fluid may be defined by the gaskets.

However, in the related art, there is a problem in that the gasket is easily deformed or separated by high pressure of the reaction fluid supplied to the water electrolysis cell. For this reason, there is a problem in that the durability and sealability of the gasket are degraded.

Moreover, when the gasket is deformed and separated, the flow path defined by the gasket (a channel through which the reaction fluid flows) is clogged, which causes a problem in that the performance, stability, and reliability of the water electrolysis cell are degraded.

Therefore, recently, various studies have been conducted to minimize the deformation and separation of the gasket and ensure the durability and sealability of the gasket, but the study results have been still insufficient. Accordingly, there is a need to develop a technology to minimize the deformation and separation of the gasket and ensure the durability and sealability of the gasket.

### SUMMARY

The present disclosure relates to an electrochemical device, and more particularly, to an electrochemical device capable of stably ensuring sealing performance and improving stability and reliability.

An embodiment of the present disclosure can provide an electrochemical device capable of stably ensuring sealing performance and improving stability and reliability.

An embodiment of the present disclosure can minimize deformation and separation of a sealing part and stably ensure sealing performance implemented by the sealing part.

An embodiment of the present disclosure can ensure structural rigidity and durability of the sealing part by minimizing deformation and separation of the sealing part caused by high pressure of a reaction fluid supplied to the electrochemical device.

An embodiment of the present disclosure can improve durability and prolong a lifespan.

An embodiment of the present disclosure can simplify a structure and a manufacturing process and reduce costs.

An embodiment of the present disclosure can easily replace the sealing part.

Advantages to be achieved by some embodiments are not limited to the above-mentioned advantages, but also can include advantages or effects that may be understood from the solutions or example embodiments described below.

To achieve the above-mentioned advantages, an example embodiment of the present disclosure provides an electrochemical device, which can include: a membrane electrode assembly (MEA); a separator stacked on the membrane electrode assembly and including a flow path portion provided to face the membrane electrode assembly, a manifold portion through which a reaction fluid is introduced or discharged, and a through-hole provided between the flow path portion and the manifold portion and configured to guide the reaction fluid, which has passed through the manifold portion, to the flow path portion; and a sealing part selectively separably stacked on the separator and configured to define a connection channel configured to connect the manifold portion and the flow path portion through the through-hole, in which the sealing part can includes a first elastic sheet, a second elastic sheet stacked on the first elastic sheet, and a reinforcement sheet having relatively higher rigidity than the first elastic sheet and the second elastic sheet and interposed between the first elastic sheet and the second elastic sheet.

A sealing part of an embodiment of the present disclosure can stably ensure sealing performance of the electrochemical device and improve stability and reliability of the electrochemical device.

That is, in the related art, there is a problem in that a gasket can be easily deformed or separated by high pressure of the reaction fluid supplied to the water electrolysis cell. For this reason, there can be a problem in that the durability and sealability of the gasket of the related art can be degraded. Moreover, when a gasket of the related art is deformed and separated, the flow path defined by the gasket (a channel through which the reaction fluid flows) can be clogged, which can cause a problem in that the performance, stability, and reliability of the water electrolysis cell can be degraded.

In contrast, in an embodiment of the present disclosure, the sealing part can include a reinforcement sheet having relatively higher rigidity than a first elastic sheet and a second elastic sheet. Therefore, in an embodiment of the present disclosure, it can be possible to obtain an advantageous effect of minimizing the deformation and separation of the sealing part and stably ensuring the sealing performance implemented by the sealing part.

Among other things, in an embodiment of the present disclosure, the sealing part can include a reinforcement sheet. Therefore, in an embodiment of the present disclosure, it can be possible to obtain an advantageous effect of ensuring the structural rigidity and durability of the sealing part by minimizing the deformation and separation of the sealing part caused by high pressure of the reaction fluid supplied to the electrochemical device.

In an embodiment of the present disclosure, the reinforcement sheet may have various structures in accordance with required conditions and design specifications.

According to an example embodiment of the present disclosure, a reinforcement sheet may include: a main sheet body interposed between a first elastic sheet and a second elastic sheet; and sheet protrusions provided on two opposite surfaces of the main sheet body and configured to support the first elastic sheet and the second elastic sheet in a state in which the first elastic sheet and the second elastic sheet are spaced apart from the main sheet body.

In an embodiment of the present disclosure, sheet protrusions can support the first elastic sheet and the second elastic sheet in a state in which the first elastic sheet and the second elastic sheet are spaced apart from the main sheet body, such that a space (a gap between the main sheet body and the first elastic sheet), in which the first elastic sheet may be elastically deformed, may be ensured between the main sheet body and the first elastic sheet (or the second elastic sheet). Therefore, in an embodiment of the present disclosure, it can be possible to obtain an advantageous effect of minimizing a situation in which the first elastic sheet and the second elastic sheet are excessively compressed by fastening pressure (pressing force) applied to the water electrolysis cell or pressure of the reaction fluid supplied to the water electrolysis cell. In an embodiment of the present disclosure, it can be possible to obtain an advantageous effect of more effectively suppressing deformation of and damage to the first elastic sheet and the second elastic sheet.

The sealing part may have various structures capable of sealing the gap between the membrane electrode assembly and the separator and the gap between the adjacent separators and defining the connection channel configured to connect the manifold portion and the flow path portion.

According to an example embodiment of the present disclosure, the sealing part may include a first sealing member provided on one surface (e.g., the bottom surface based on FIG. 1) of the separator and configured to define first connection channels configured to connect the manifold portions and the through-holes, and a second sealing member provided on the other surface (e.g., the top surface based on FIG. 1) of the separator provided to face the membrane electrode assembly, the second sealing member being configured to define second connection channels configured to connect the through-holes and the flow path portion. The first connection channel and the second connection channel may collectively define the connection channel.

The first sealing member may have various structures capable of defining the first connection channel configured to connect the manifold portion and the through-hole on one surface (e.g., the bottom surface based on FIG. 1) of the separator.

According to an example embodiment of the present disclosure, the first sealing member may include: a first-first body sealing portion provided along an edge of the separator; a first-second body sealing portion provided to surround the manifold portion and the through-hole and connected to the first-first body sealing portion; and a plurality of first guide sealing portions connected to the first-second body sealing portion and configured to define the first connection channel.

According to an example embodiment of the present disclosure, the electrochemical device may include a first connection sealing portion configured to continuously connect ends of the first guide sealing portions adjacent to the manifold portion.

In an embodiment of the present disclosure, the ends of the first guide sealing portions adjacent to the manifold portion can be continuously connected by the first connection sealing portion. Therefore, in an embodiment of the present disclosure, it can be possible to obtain an advantageous effect of minimizing a situation in which the end of the first guide sealing portion (e.g., the free end of the first guide sealing portion having the cantilevered beam structure) from being bent or deformed.

According to an example embodiment of the present disclosure, the electrochemical device may include a support rib extending from the separator and configured to support the first connection sealing portion on the separator.

In an embodiment of the present disclosure, the first connection sealing portions can be supported on the support ribs. Therefore, in an embodiment of the present disclosure, it can be possible to obtain an advantageous effect of minimizing the sag and deformation of the first connection sealing portions and stably maintaining the arrangement state of the first connection sealing portions.

The second sealing member may have various structures capable of defining the second connection channel configured to connect the through-hole and the flow path portion on the other surface (e.g., the top surface based on FIG. 1) of the separator.

According to an example embodiment of the present disclosure, the second sealing member may include: a second-first body sealing portion provided along an edge of the separator; a second-second body sealing portion provided to surround the manifold portion and connected to the second-first body sealing portion; and a plurality of second guide sealing portions connected to the second-second body sealing portion and configured to define the second connection channel.

According to an example embodiment of the present disclosure, the electrochemical device may include a second connection sealing portion configured to continuously connect ends of the second guide sealing portions adjacent to the flow path portion.

In an embodiment of the present disclosure, the ends of the second guide sealing portions adjacent to the flow path portion can be continuously connected by the second connection sealing portion. Therefore, in an embodiment of the present disclosure, it can be possible to obtain an advantageous effect of minimizing a situation in which the end of the second guide sealing portion (e.g., the free end of the second guide sealing portion having the cantilevered beam structure) from being bent or deformed.

According to an example embodiment of the present disclosure, the electrochemical device may include: an extension flow path provided on the separator so that one end of the extension flow path communicates with the second connection channel, and the other end of the extension flow path communicates with the flow path portion, in which the second connection sealing portion is provided to partially cover the extension flow path.

According to an example embodiment of the present disclosure, the electrochemical device may include a stopper portion provided on the separator and configured to restrict a horizontal movement of the sealing part relative to the separator.

The stopper portion may have various structures capable of restricting the horizontal movement of the sealing part relative to the separator.

According to an example embodiment of the present disclosure, the stopper portion may include: a first stopper protrusion configured to support one side surface of the sealing part; and a second stopper protrusion provided to face the first stopper protrusion and configured to support the other side surface of the sealing part.

In an embodiment of the present disclosure, the stopper portion can restrict the horizontal movement of the sealing part relative to the separator. Therefore, in an embodiment of the present disclosure, it can be possible to obtain an advantageous effect of minimizing the deformation and separation of the sealing part caused by high pressure of the reaction fluid supplied to the electrochemical device and stably maintaining the arrangement state of the sealing part.

According to an example embodiment of the present disclosure, the electrochemical device may include: an alignment protrusion connected to the sealing part; and an alignment groove provided in the separator and configured to accommodate the alignment protrusion.

In an embodiment of the present disclosure, the alignment protrusion connected to the sealing part can be accommodated in the alignment groove provided in the separator. Therefore, in an embodiment of the present disclosure, it can be possible to obtain an advantageous effect of minimizing the misalignment of the sealing part with respect to the separator when the sealing part is seated on the separator. In an embodiment of the present disclosure, it can be possible to obtain an advantageous effect of more stably maintaining the state in which the sealing part is seated on the separator.

According to an example embodiment of the present disclosure, the electrochemical device may include: a first alignment hole provided in the alignment protrusion; and a second alignment hole provided in the separator while corresponding to the first alignment hole.

In an embodiment of the present disclosure, the first alignment hole and the second alignment hole can be respectively provided in the alignment protrusion and the separator, and the separator and the sealing part can be stacked in the state in which the alignment rod is fitted into the first alignment hole and the second alignment hole, such that the misalignment of the sealing part with respect to the separator may be prevented, and the process of aligning the separator and the sealing part may be simplified. Therefore, in an embodiment of the present disclosure, it can be possible to obtain an advantageous effect of improving the productivity and reducing the amount of time required for the process of assembling the separator and the sealing part.

An example embodiment of the present disclosure provides an electrochemical device, which can include: a membrane electrode assembly (MEA); a separator stacked on the membrane electrode assembly and including a flow path portion provided to face the membrane electrode assembly, a manifold portion through which a reaction fluid is introduced or discharged, and a through-hole provided between the flow path portion and the manifold portion and configured to guide the reaction fluid, which has passed through the manifold portion, to the flow path portion; support ribs extending from the separator and protruding toward the inside of the manifold portion; a through-portion defined between the adjacent support ribs; and a sealing part including a first sealing member provided on one surface of the separator and configured to define a first connection channel configured to connect the manifold portion and the through-hole, and a second sealing member provided on the other surface of the separator, which faces the membrane electrode assembly, and configured to define a second connection channel configured to connect the through-hole and the flow path portion, in which an inlet end of the first connection channel is defined to communicate with the through-portion in a thickness direction of the separator.

According to an example embodiment of the present disclosure, the first sealing member may include: a first-first body sealing portion provided along an edge of the separator; a first-second body sealing portion provided to surround the manifold portion and the through-hole and connected to the first-first body sealing portion; a plurality of first guide sealing portions connected to the first-second body sealing portion and configured to define the first connection channel; and a first connection sealing portion configured to continuously connect ends of the first guide sealing portions adjacent to the manifold portion, the first connection sealing portion being supported on the support rib and configured to partially cover a part of the through-portion, and the reaction fluid introduced into the manifold portion may flow along the first connection channel, which is provided on one surface of the separator, through the through-portion on the other surface of the separator.

According to an example embodiment of the present disclosure, the second sealing member may include: a second-first body sealing portion provided along an edge of the separator; a second-second body sealing portion provided to surround the manifold portion and connected to the second-first body sealing portion; and a plurality of second guide sealing portions connected to the second-second body sealing portion and configured to define the second connection channel.

According to an example embodiment of the present disclosure, the electrochemical device may include a second connection sealing portion configured to continuously connect ends of the second guide sealing portions adjacent to the flow path portion.

According to an example embodiment of the present disclosure, the electrochemical device may include an extension flow path provided on the separator so that one end of the extension flow path communicates with the second connection channel, and the other end of the extension flow path communicates with the flow path portion, in which the second connection sealing portion is provided to partially cover the extension flow path.

According to an example embodiment of the present disclosure, the sealing part may include: a first elastic sheet; a second elastic sheet stacked on the first elastic sheet; and a reinforcement sheet having relatively higher rigidity than the first elastic sheet and the second elastic sheet and interposed between the first elastic sheet and the second elastic sheet.

According to an example embodiment of the present disclosure, the reinforcement sheet may include: a main sheet body interposed between the first elastic sheet and the second elastic sheet; and sheet protrusions provided on two opposite surfaces of the main sheet body and configured to support the first elastic sheet and the second elastic sheet in a state in which the first elastic sheet and the second elastic sheet are spaced apart from the main sheet body.

According to an example embodiment of the present disclosure, the electrochemical device may include a stopper portion provided on the separator and configured to restrict a horizontal movement of the sealing part relative to the separator.

According to an example embodiment of the present disclosure, the stopper portion may include: a first stopper protrusion configured to support one side surface of the sealing part; and a second stopper protrusion provided to face the first stopper protrusion and configured to support the other side surface of the sealing part.

According to an example embodiment of the present disclosure, the electrochemical device may include: an alignment protrusion connected to the sealing part; and an alignment groove provided in the separator and configured to accommodate the alignment protrusion.

According to an example embodiment of the present disclosure, the electrochemical device may include: a first alignment hole provided in the alignment protrusion; and a second alignment hole provided in the separator while corresponding to the first alignment hole.

According to an embodiment of the present disclosure, it can be possible to obtain an advantageous effect of stably ensuring the sealing performance and improving the stability and reliability.

According to an embodiment of the present disclosure, it can be possible to obtain an advantageous effect of minimizing the deformation and separation of the sealing part and stably ensuring the sealing performance implemented by the sealing part.

Among other things, according to an embodiment of the present disclosure, it can be possible to obtain an advantageous effect of ensuring the structural rigidity and durability of the sealing part by minimizing the deformation and separation of the sealing part caused by high pressure of the reaction fluid supplied to the electrochemical device.

According to an embodiment of the present disclosure, it can be possible to obtain an advantageous effect of improving the durability and prolonging the lifespan.

According to an embodiment of the present disclosure, it can be possible to obtain an advantageous effect of simplifying the structure and the manufacturing process and reducing the costs.

According to an embodiment of the present disclosure, it can be possible to easily replace the sealing part.

### BRIEF DESCRIPTION OF THE DRAWINGS

FIG. 1 is a cross-section view for explaining an electrochemical device according to an embodiment of the present disclosure.

FIG. 2 is a plan view for explaining a separator of an electrochemical device according to an embodiment of the present disclosure.

FIG. 3 is a plan view for explaining a first sealing member of an electrochemical device according to an embodiment of the present disclosure.

FIG. 4 is a plan view for explaining a state in which a separator and a first sealing member of an electrochemical device according to an embodiment of the present disclosure are stacked.

FIG. 5 is a plan view for explaining a second sealing member of an electrochemical device according to an embodiment of the present disclosure.

FIG. 6 is a plan view for explaining a state in which a separator and a second sealing member of an electrochemical device according to an embodiment of the present disclosure are stacked.

FIG. 7 is a close-up cross-section view for explaining a stopper portion of an electrochemical device according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings.

However, the technical spirit of the present disclosure is not necessarily limited to some embodiments described herein but may be implemented in various different forms. One or more of the constituent elements in the embodiments may be selectively combined and substituted for use within scopes of the technical spirit of the present disclosure.

Unless otherwise specifically and explicitly defined and stated, terms (including technical and scientific terms) used in describing example embodiments of the present disclosure may be construed as having meanings commonly understood by the person with ordinary skill in the art to which the present disclosure pertains. Meanings of commonly used terms, such as the terms defined in dictionaries, may be interpreted in consideration of the contextual meanings of the related technology.

Terms used in describing example embodiments of the present disclosure are for explaining the example embodiments, not for necessarily limiting the present disclosure.

In the present specification, unless particularly stated otherwise, a singular form may also include a plural form. The expression “at least one (or one or more) of A, B, and C” may include one or more of all combinations that can be made by combining A, B, and C.

Terms such as “first,” “second,” “A,” “B,” “(a),” and “(b)” may be used to describe constituent elements of the embodiments of the present disclosure.

These terms can be used merely for the purpose of discriminating one constituent element from another constituent element, and the nature, the sequences, or the orders of the constituent elements are not necessarily limited by these terms.

Further, when one constituent element is described as being “connected,” “coupled,” or “attached” to another constituent element, one constituent element may be connected, coupled, or attached directly to another constituent element, or may be connected, coupled, or attached to another constituent element through still another constituent element interposed therebetween.

The expression “one constituent element is provided or disposed above (on) or below (under) another constituent element” can include not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

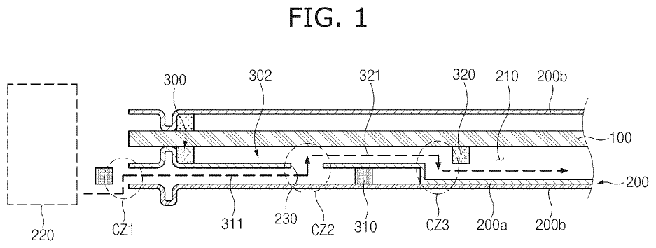

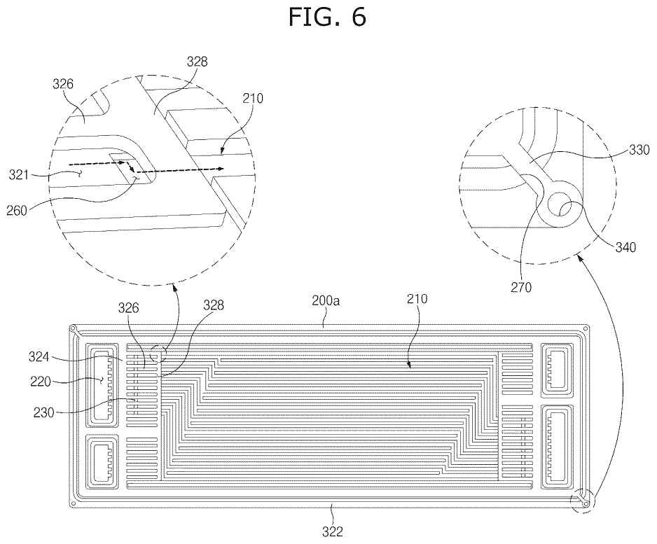

With reference to FIGS. 1 to 7, an electrochemical device can include a membrane electrode assembly (MEA) 100; separators 200 each including a flow path portion 210 facing the membrane electrode assembly 100, manifold portions 220 through which a reaction fluid is introduced or discharged, and through-holes 230 provided between the flow path portion 210 and the manifold portions 220 and configured to guide the reaction fluid, which has passed through the manifold portions 220, to the flow path portion 210, the separator 200 being stacked on the membrane electrode assembly 100; and a sealing part 300 selectively separably stacked on the separator 200 and configured to define a connection channel 302 configured to connect the manifold portions 220 and the flow path portion 210 through the through-holes 230. The sealing part 300 can include a first elastic sheet 304, a second elastic sheet 306 stacked on the first elastic sheet 304, and a reinforcement sheet 308 having relatively higher rigidity than the first elastic sheet 304 and the second elastic sheet 306 and interposed between the first elastic sheet 304 and the second elastic sheet 306.

In an embodiment of the present disclosure, an electrochemical device can include a steam electrolysis stack configured to produce hydrogen and oxygen by electrochemically decomposing water and/or a fuel cell stack configured to generate electrical energy through a chemical reaction of fuel (e.g., hydrogen).

Hereinafter, an example will be described in which the electrochemical device according to an embodiment of the present disclosure is used as the steam electrolysis stack that produces hydrogen and oxygen by decomposing water through an electrochemical reaction.

With reference to FIG. 1, the water electrolysis stack (electrochemical device) may be configured by stacking several tens or several hundreds of unit cells (water electrolysis cells) in a reference stacking direction (e.g., an upward/downward direction based on FIG. 1).

More specifically, the unit cell may include a reaction layer and the separators 200 (first and second separators 200a and 200b) respectively stacked on one surface and the other surface of the reaction layer. The water electrolysis stack may be configured by stacking the plurality of unit cells in the reference stacking direction and then assembling endplates to the two opposite ends of the plurality of unit cells.

The reaction layer may have various structures capable of generating the electrochemical reaction of the reaction fluid (e.g., water). An embodiment of the present disclosure is not necessarily restricted or limited by the type and structure of the reaction layer.

For example, the reaction layer may include a membrane electrode assembly (MEA) 100, a first porous transport layer (not illustrated) being in close contact with one surface of the membrane electrode assembly 100, and a second porous transport layer (not illustrated) being in close contact with the other surface of the membrane electrode assembly 100.

The membrane electrode assembly 100 may be variously changed in structure and material in accordance with required conditions and design specifications, and an embodiment of the present disclosure is not necessarily limited or restricted by the structure and material of the membrane electrode assembly 100.

For example, the membrane electrode assembly 100 may include a solid oxide cell, and porous current collecting layers provided to be in close contact with two opposite surfaces of the solid oxide cell.

The solid oxide cell may be variously changed in structure and material in accordance with required conditions and design specifications. An embodiment of the present disclosure is not necessarily restricted or limited by the structure and material of the solid oxide cell.

For example, a solid oxide cell assembly may be configured by attaching catalyst electrode layers (e.g., an anode layer and a cathode layer), in which electrochemical reactions are generated, to two opposite surfaces of an electrolyte layer (e.g., yttria-stabilized zirconia (YSZ)).

For reference, water supplied to a fuel electrode layer (anode), which is a reduction electrode for the steam electrolysis, is separated into hydrogen, electrons, and oxygen ions. Then, the oxygen ions move to an air electrode layer (cathode), which is an oxidation electrode, through an electrolyte membrane, and the electrons move through an external circuit. The hydrogen gas may be discharged to a fuel electrode outlet. The oxygen ions may be converted into oxygen gas in an air electrode, and the oxygen gas may be discharged to an air electrode outlet.

The separators 200, together with the reaction layer, constitute a single unit cell (water electrolysis cell). The separators serve to block hydrogen and water separated by the reaction layer and ensure flow paths (flow fields) through which hydrogen and water flow.

The separator 200 may also serve to distribute heat, which is generated from the unit cell, to the entire unit cell, and the excessively generated heat may be discharged to the outside by the fluid flowing along the separator 200.

For reference, in an embodiment of the present disclosure, the separators 200 can include both a cathode separator 200 and an anode separator 200 that independently define the flow paths (channels) for water (or water and oxygen) and the flow paths (channels) for hydrogen in the water electrolysis stack.

For example, the first separator 200a (anode separator), which faces one surface (a bottom surface based on FIG. 1) of the membrane electrode assembly 100, may define the flow path (channel) for water (or water and hydrogen), and the second separator 200b (cathode separator), which faces the other surface (a top surface based on FIG. 1) of the membrane electrode assembly 100, may define the flow path (channel) for oxygen (air).

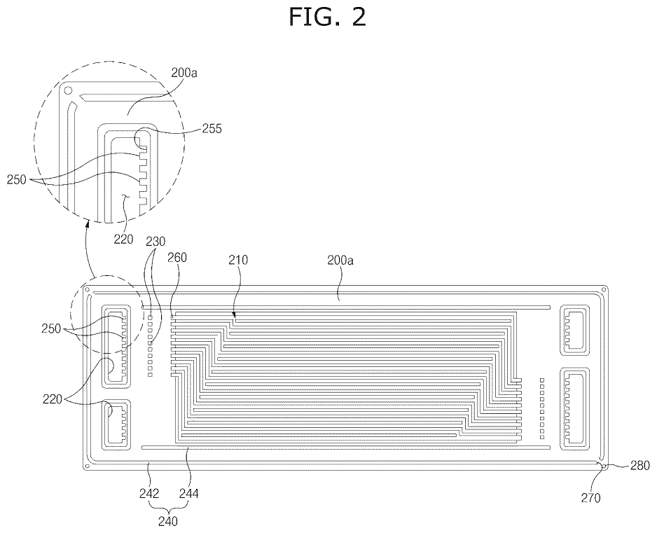

With reference to FIGS. 1 and 2, the separator 200 can include the manifold portion 220 through which the reaction fluid is introduced or discharged, the flow path portion 210 spaced apart from the manifold portion 220 and configured to define a reaction region configured to react with the membrane electrode assembly 100, and the through-holes 230 provided between the manifold portions 220 and the flow path portion 210 and configured to guide the reaction fluid, which has passed through the manifold portions 220, to the flow path portion 210.

The separator 200 may have various structures and be made of various materials in accordance with required conditions and design specifications. An embodiment of the present disclosure is not necessarily restricted or limited by the structure and material of the separator 200.

For example, the separator 200 may be provided in the form of an approximately quadrangular plate and made of a typical metallic material (e.g., titanium, stainless steel, Inconel, or aluminum). According to an embodiment of the present disclosure, the separator may be made of another material such as graphite or a carbon composite.

The flow path portion 210 can be disposed at an approximately central portion of the separator 200 and can face one surface of the membrane electrode assembly 100 to define the reaction region.

The flow path portion 210 may include a plurality of flow paths (channels) disposed to be spaced apart from one another. An embodiment of the present disclosure is not necessarily restricted or limited by the number of flow paths and the arrangement structure of the flow paths.

The manifold portions 220 (e.g., water manifolds and oxygen manifolds) can be penetratively provided at two opposite ends of the separator 200 based on a longitudinal direction with the flow path portion 210 interposed therebetween. The manifold portions 220 can serve to allow hydrogen, water, and oxygen to flow (supply and discharge hydrogen, water, and oxygen).

The manifold portion 220 may be variously changed in number and arrangement interval in accordance with required conditions and design specifications. An embodiment of the present disclosure is not necessarily restricted or limited by the number of manifold portions 220 and the arrangement interval between the manifold portions 220.

For example, with reference to FIG. 2, the two manifold portions 220 may be provided at one end (a left end) of the separator 200, and the two manifold portions 220 may be provided at the other end (a right end) of the separator 200.

The manifold portion 220 may be variously changed in structure and shape in accordance with required conditions and design specifications. An embodiment of the present disclosure is not necessarily restricted or limited by the structure and shape of the manifold portion 220.

For example, the manifold portion 220 may be provided to have an approximately quadrangular shape. According to an embodiment of the present disclosure, the manifold portion may have a circular or other shapes.

The through-holes 230 can be configured to guide the reaction fluid, which has passed through the manifold portions 220, to the flow path portion 210.

The through-hole 230 may have various structures capable of guiding the reaction fluid, which has passed through the manifold portion 220, to the flow path portion 210. An embodiment of the present disclosure is not necessarily restricted or limited by the structure and shape of the through-hole 230.

For example, the plurality of through-holes 230, each having an approximately quadrangular shape, may be provided between the manifold portions 220 and the flow path portion 210 and spaced apart from one another in a width direction of the first separator 200a (the upward/downward direction based on FIG. 2). Alternatively, the through-hole may have a circular shape or other shapes.

The sealing part 300 may be provided to seal a portion between the membrane electrode assembly 100 and the separator 200 and define the connection channel 302 configured to connect the manifold portions 220 and the flow path portion 210.

More specifically, the sealing part 300 can be selectively separably stacked on the separator 200 and provided to define the connection channel 302 configured to connect the manifold portions 220 and the flow path portion 210 through the through-holes 230. The sealing part 300 can include the first elastic sheet 304, the second elastic sheet 306 stacked on the first elastic sheet 304, and the reinforcement sheet 308 having relatively higher rigidity than the first elastic sheet 304 and the second elastic sheet 306 and interposed between the first elastic sheet 304 and the second elastic sheet 306.

The first elastic sheet 304 and the second elastic sheet 306 can be layers for implementing the sealing performance of the sealing part 300. The first elastic sheet 304 and the second elastic sheet 306 may be made of various elastic materials capable of being elastically tightly attached to the membrane electrode assembly 100 or the separator 200. An embodiment of the present disclosure is not necessarily restricted or limited by the materials and properties of the first elastic sheet 304 and the second elastic sheet 306.

For example, the first elastic sheet 304 and the second elastic sheet 306 may be made of various elastic materials such as Teflon, rubber, silicone, or urethane.

In particular, the first elastic sheet 304 and the second elastic sheet 306 may each be provided in the form of a flat plate-shaped sheet with a small thickness.

The reinforcement sheet 308 can be a layer for reinforcing the structural rigidity of the sealing part 300. The reinforcement sheet 308 can be interposed between the first elastic sheet 304 and the second elastic sheet 306.

The reinforcement sheet 308 may be made of various materials having relatively higher rigidity than those of the first elastic sheet 304 and the second elastic sheet 306. An embodiment of the present disclosure is not necessarily restricted or limited by the material and properties of the reinforcement sheet 308.

For example, the reinforcement sheet 308 may be made of typical metal or synthetic resin (e.g., plastic).

The reinforcement sheet 308 may have various structures in accordance with required conditions and design specifications. An embodiment of the present disclosure is not necessarily restricted or limited by the structure of the reinforcement sheet 308.

According to an example embodiment of the present disclosure, the reinforcement sheet 308 may include a main sheet body 308a interposed between the first elastic sheet 304 and the second elastic sheet 306, and sheet protrusions 308b provided on two opposite surfaces of the main sheet body 308a and configured to support the first elastic sheet 304 and the second elastic sheet 306 in a state in which the first elastic sheet 304 and the second elastic sheet 306 are spaced apart from the main sheet body 308a at predetermined intervals.

In particular, the main sheet body 308a may be provided in the form of a flat plate-shaped sheet with a small thickness.

The sheet protrusions 308b may be provided on the two opposite surfaces of the main sheet body 308a and spaced apart from one another at predetermined intervals in a longitudinal direction of the main sheet body 308a. An embodiment of the present disclosure is not necessarily restricted or limited by the size of the sheet protrusion 308b, the number of sheet protrusions 308b, and the spacing interval between the sheet protrusions 308b.

As described above, in an embodiment of the present disclosure, the sheet protrusions 308b can support the first elastic sheet 304 and the second elastic sheet 306 in a state in which the first elastic sheet 304 and the second elastic sheet 306 are spaced apart from the main sheet body 308a, such that a space (a gap between the main sheet body and the first elastic sheet), in which the first elastic sheet 304 may be elastically deformed, may be ensured between the main sheet body 308a and the first elastic sheet 304 (or the second elastic sheet). Therefore, in an embodiment of the present disclosure, it can be possible to obtain an advantageous effect of minimizing a situation in which the first elastic sheet 304 and the second elastic sheet 306 are excessively compressed by fastening pressure (pressing force) applied to the water electrolysis cell or pressure of the reaction fluid supplied to the water electrolysis cell. In an embodiment of the present disclosure, it can be possible to obtain an advantageous effect of more effectively suppressing deformation of and damage to the first elastic sheet 304 and the second elastic sheet 306.

As described above, in an embodiment of the present disclosure, the sealing part 300 can include the reinforcement sheet 308 having relatively higher rigidity than the first elastic sheet 304 and the second elastic sheet 306. Therefore, in an embodiment of the present disclosure, it can be possible to obtain an advantageous effect of minimizing the deformation and separation of the sealing part 300 and stably ensuring the sealing performance implemented by the sealing part 300.

Among other things, in an embodiment of the present disclosure, the sealing part 300 can include the reinforcement sheet 308. Therefore, in an embodiment of the present disclosure, it can be possible to obtain an advantageous effect of minimizing the deformation and separation of the sealing part 300 caused by high pressure of the reaction fluid supplied to the electrochemical device and ensuring the structural rigidity and durability of the sealing part 300.

In an embodiment of the present disclosure, the sealing part 300 can include the reinforcement sheet 308 having relatively higher rigidity than the first elastic sheet 304 and the second elastic sheet 306, such that the sealing part 300 may autonomously ensure the structural rigidity without depending on the separator 200. Therefore, in an embodiment of the present disclosure, it can be possible to manufacture the sealing part 300 separately from and independently of the separator 200 and provide the sealing part 300.

That is, in the related art, because it can be difficult for the sealing part 300 to autonomously have the structural rigidity, the sealing part 300 needs to be integrated with the separator 200 (e.g., the sealing part is provided by injection molding) to ensure the structural rigidity of the sealing part 300. For this reason, there can be a problem in that the process of manufacturing the sealing part 300 can be complicated and the manufacturing costs can be increased.

However, in an embodiment of the present disclosure, the sealing part 300 autonomously has the structural rigidity, such that the water electrolysis cell may be manufactured by simply stacking the sealing part 300, which can be manufactured independently of the separator 200, on the separator 200 without the complicated process of having to manufacture the separator 200 and the sealing part 300 by injection molding. Therefore, in an embodiment of the present disclosure, it can be possible to obtain an advantageous effect of reducing costs and simplifying the processes of manufacturing and assembling the water electrolysis cell.

The sealing part 300 may have various structures capable of sealing a gap between the membrane electrode assembly 100 and the separator 200 and a gap between the adjacent separators 200 and defining the connection channel 302 configured to connect the manifold portion 220 and the flow path portion 210. An embodiment of the present disclosure is not necessarily restricted or limited by the structure of the sealing part 300.

According to an example embodiment of the present disclosure, the sealing part 300 may include a first sealing member 310 provided on one surface (the bottom surface based on FIG. 1) of the separator 200 and configured to define first connection channels 311 configured to connect the manifold portions 220 and the through-holes 230, and a second sealing member 320 provided on the other surface (the top surface based on FIG. 1) of the separator 200 provided to face the membrane electrode assembly 100, the second sealing member 320 being configured to define second connection channels 321 configured to connect the through-holes 230 and the flow path portion 210. The first connection channel 311 and the second connection channel 321 may collectively define the connection channel 302.

The first sealing member 310 may have various structures capable of defining the first connection channel 311 provided on one surface (the bottom surface based on FIG. 1) of the separator 200 and configured to connect the manifold portion 220 and the through-hole 230. An embodiment of the present disclosure is not necessarily restricted or limited by the structure and shape of the first sealing member 310.

With reference to FIGS. 1 to 4, according to an example embodiment of the present disclosure, the first sealing member 310 may include a first-first body sealing portion 312 provided along an edge of the separator 200, first-second body sealing portions 314 provided to surround the manifold portions 220 and the through-holes 230 and connected to the first-first body sealing portion 312, and a plurality of first guide sealing portions 316 connected to the first-second body sealing portions 314 and configured to define the first connection channels 311.

For example, the first-first body sealing portion 312 may have a closed loop structure provided along the edge of the separator 200 and have an approximately quadrangular ring shape. The first-second body sealing portion 314 may have a closed loop structure having an approximately quadrangular ring shape that surrounds the manifold portions 220 and the through-holes 230.

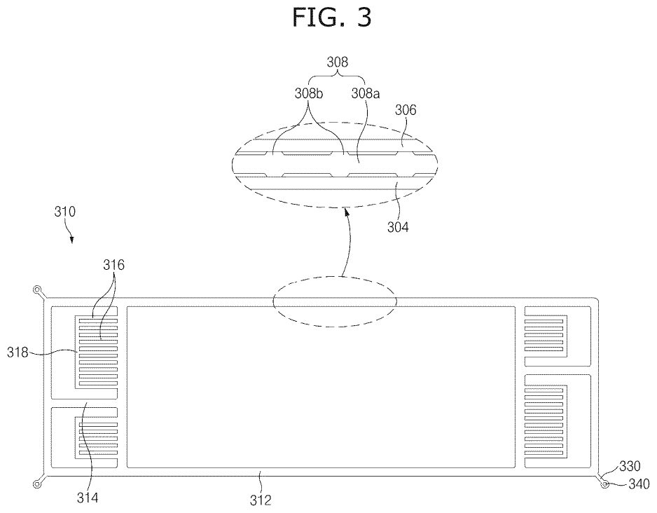

The first guide sealing portion 316 may have an approximate comb shape (cantilevered beam structure) directed toward the manifold portion 220. The plurality of first guide sealing portions 316 may be spaced apart from one another in a longitudinal direction of the first-second body sealing portion 314 (the upward/downward direction based on FIG. 3). The first connection channel 311 may be defined between the adjacent first guide sealing portions 316 and have an approximately straight shape that connects the manifold portion 220 and the through-hole 230 so that the manifold portion 220 and the through-hole 230 communicate with each other.

According to an example embodiment of the present disclosure, the electrochemical device may include first connection sealing portions 318 configured to continuously connect ends of the first guide sealing portions 316 adjacent to the manifold portions 220.

The first connection sealing portion 318 can be provided to continuously connect the ends of the adjacent first guide sealing portions 316 to prevent the end of the first guide sealing portion 316 (a free end of the first guide sealing portion 316 having the cantilevered beam structure) from being bent or deformed.

The first connection sealing portion 318 may have various structures capable of continuously connecting the ends of the adjacent first guide sealing portions 316 and partially covering a part of a through-portion 255. An embodiment of the present disclosure is not necessarily restricted or limited by the structure and shape of the first connection sealing portion 318.

For example, the first connection sealing portion 318 may have an approximately straight shape. According to an embodiment of the present disclosure, the first connection sealing portion may have a curved shape or other shapes.

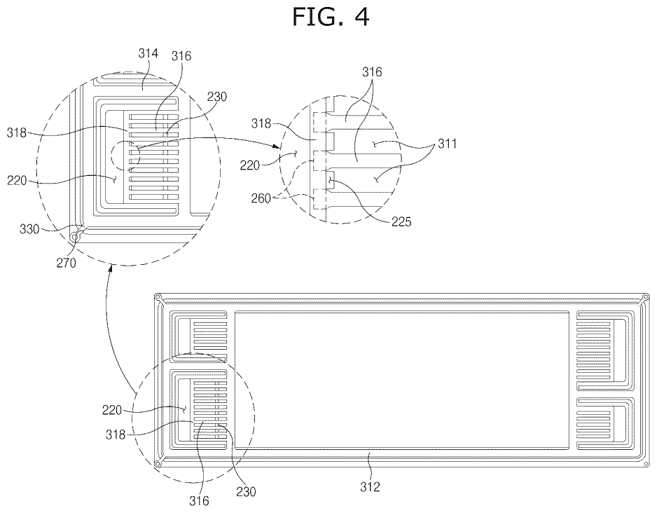

With reference to FIGS. 2 and 4, according to an example embodiment of the present disclosure, the electrochemical device may include support ribs 250 extending from the separator 200 and configured to support the first connection sealing portions 318 on the separator 200.

The support rib 250 may have various structures capable of extending from the separator 200 toward the inside of the manifold portion 220 and supporting the first connection sealing portion 318 on the separator 200. An embodiment of the present disclosure is not necessarily restricted or limited by the structure and shape of the support rib 250.

For example, the support rib 250 may have an approximately quadrangular protrusion shape. The plurality of support ribs 250 may be spaced apart from one another along an inner wall surface of the manifold portion 220 (in the upward/downward direction based on FIG. 2).

The through-portion 255 may be provided between the adjacent support ribs 250 and connect the manifold portion 220 and the first connection channel 311 so that the manifold portion 220 and the first connection channel 311 communicate with each other. The first connection sealing portion 318 may be supported on the support rib 250 and partially cover a part of the through-portion 255. Therefore, an inlet end of the first connection channel 311 may communicate with the through-portion 255 in a thickness direction of the separator 200, and the reaction fluid introduced into the manifold portion 220 may be supplied to the first connection channel 311 through the through-portion 255.

As described above, in an embodiment of the present disclosure, the first connection sealing portions 318 can be supported on the support ribs 250. Therefore, in an embodiment of the present disclosure, it can be possible to obtain an advantageous effect of minimizing the sag and deformation of the first connection sealing portions 318 and stably maintaining the arrangement state of the first connection sealing portions 318.

The second sealing member 320 may have various structures capable of defining the second connection channel 321 provided on the other surface (the top surface based on FIG. 1) of the separator 200 and configured to connect the through-hole 230 and the flow path portion 210. An embodiment of the present disclosure is not necessarily restricted or limited by the structure and shape of the second sealing member 320.

With reference to FIGS. 1, 5, and 6, according to an example embodiment of the present disclosure, the second sealing member 320 may include a second-first body sealing portion 322 provided along the edge of the separator 200, second-second body sealing portions 324 configured to surround the manifold portions 220 and connected to the second-first body sealing portion 322, and a plurality of second guide sealing portions 326 connected to the second-second body sealing portions 324 and configured to define the second connection channels 321.

For example, the second-first body sealing portion 322 may have a closed loop structure provided along the edge of the separator 200 and have an approximately quadrangular ring shape. The second-second body sealing portion 324 may have a closed loop structure having an approximately quadrangular ring shape that surrounds the manifold portion 220.

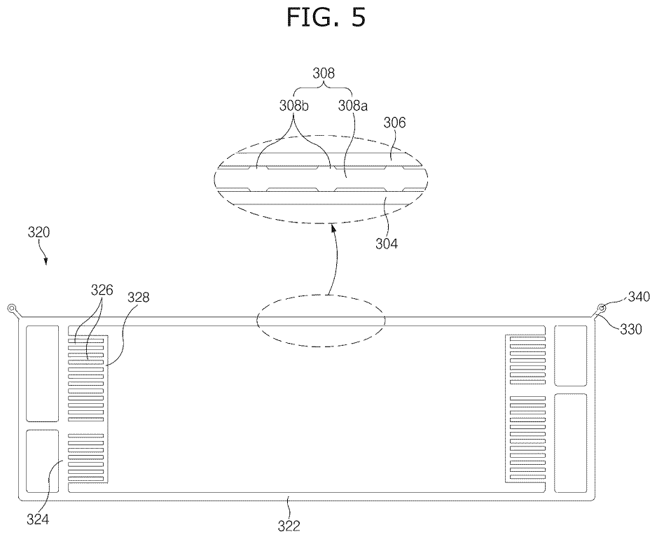

The second guide sealing portion 326 may have an approximate comb shape (cantilevered beam structure) directed toward the flow path portion 210. The plurality of second guide sealing portions 326 may be spaced apart from one another in a longitudinal direction of the second-second body sealing portion 324 (the upward/downward direction based on FIG. 5). The second connection channel 321 may be defined between the adjacent second guide sealing portions 326 and have an approximately straight shape that connects the through-hole 230 and the flow path portion 210 so that the through-hole 230 and the flow path portion 210 communicate with each other.

According to an example embodiment of the present disclosure, the electrochemical device may include second connection sealing portions 328 configured to continuously connect ends of the second guide sealing portions 326 adjacent to the flow path portion 210.

The second connection sealing portion 328 can be provided to continuously connect the ends of the adjacent second guide sealing portions 326 to prevent the end of the second guide sealing portion 326 (a free end of the second guide sealing portion 326 having the cantilevered beam structure) from being bent or deformed.

The second connection sealing portion 328 may have various structures capable of continuously connecting the ends of the adjacent second guide sealing portions 326. An embodiment of the present disclosure is not necessarily restricted or limited by the structure and shape of the second connection sealing portion 328.

For example, the second connection sealing portion 328 may have an approximately straight shape. According to an embodiment of the present disclosure, the second connection sealing portion may have a curved shape or other shapes.

According to an example embodiment of the present disclosure, the electrochemical device may include extension flow paths 260 provided in the separator 200 so that one end of each of the extension flow paths 260 communicates with the second connection channel 321, and the other end of each of the extension flow paths 260 communicates with the flow path portion 210. The second connection sealing portion 328 may be provided to partially cover the extension flow path 260.

For example, the extension flow path 260 may be stepped from the second connection channel 321 and have a recessed shape provided below the second connection sealing portion 328.

With the above-mentioned structure, the reaction fluid introduced into the manifold portion 220 may be supplied to the through-holes 230 along the first connection channels 311 on one surface (the bottom surface based on FIG. 1) of the separator 200. The reaction fluid having passed through the through-holes 230 may be supplied to the flow path portion 210 along the second connection channels 321 on the other surface (the top surface based on FIG. 1) of the separator 200.

In this example, the reaction fluid may flow through a first bent section CZ1 in which the manifold portion 220 and the inlet end of the first connection channel 311 are connected, a second bent section CZ2 in which an outlet end of the first connection channel 311 and the through-hole 230 are connected, and a third bent section CZ3 in which an outlet end of the second connection channel 321 and the flow path portion 210 are connected.

As described above, in an embodiment of the present disclosure, because the reaction fluid introduced into the manifold portion 220 flows through the first bent section CZ1, the second bent section CZ2, and the third bent section CZ3, such that the pressure of the reaction fluid (particularly, high pressure of the reaction fluid supplied to the water electrolysis cell) may be mitigated. Therefore, in an embodiment of the present disclosure, it can be possible to obtain an advantageous effect of minimizing the deformation and separation of the sealing part 300 and stably ensuring the sealability of the electrochemical device 10.

Among other things, in an embodiment of the present disclosure, the reaction fluid introduced into the manifold portion 220 flows along the first connection channels 311, which can be provided on one surface of the separator 200, through the through-portions 255 on the other surface of the separator. Therefore, in an embodiment of the present disclosure, it can be possible to obtain an advantageous effect of minimizing the deformation and separation of the sealing part 300 caused by the pressure of the reaction fluid.

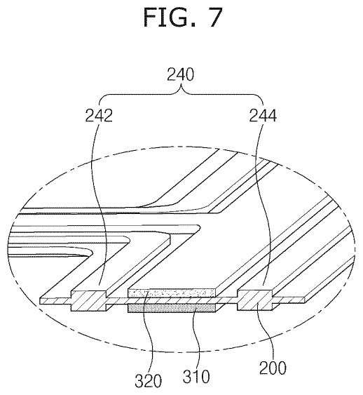

With reference to FIGS. 2 and 7, according to an example embodiment of the present disclosure, the electrochemical device may include a stopper portion 240 provided on the separator 200 and configured to restrict a horizontal movement of the sealing part 300 relative to the separator 200.

The stopper portion 240 may have various structures capable of restricting the horizontal movement of the sealing part 300 relative to the separator 200. An embodiment of the present disclosure is not necessarily restricted or limited by the structure of the stopper portion 240.

According to an example embodiment of the present disclosure, the stopper portion 240 may include a first stopper protrusion 242 configured to support one side surface of the sealing part 300, and a second stopper protrusion 244 provided to face the first stopper protrusion 242 and configured to support the other side surface of the sealing part 300.

For example, the first stopper protrusion 242 and the second stopper protrusion 244 may each have a continuous line shape along a lateral surface of the sealing part 300.

According to an embodiment of the present disclosure, a plurality of first stopper protrusions and a plurality of second stopper protrusions can be spaced apart from one another along the lateral surface of the sealing part. Alternatively, the sealing part may include only any one of the first stopper protrusion or the second stopper protrusion.

As described above, in an embodiment of the present disclosure, the stopper portion 240 can restrict the horizontal movement of the sealing part 300 relative to the separator 200. Therefore, in an embodiment of the present disclosure, it can be possible to obtain an advantageous effect of minimizing the deformation and separation of the sealing part 300 caused by high pressure of the reaction fluid supplied to the electrochemical device and stably maintaining the arrangement state of the sealing part 300.

With reference to FIGS. 2 to 6, according to an example embodiment of the present disclosure, the electrochemical device may include alignment protrusions 330 connected to the sealing part 300, and alignment grooves 270 provided in the separator 200 and configured to accommodate the alignment protrusions 330.

The alignment protrusion 330 may have various structures in accordance with required conditions and design specifications. An embodiment of the present disclosure is not necessarily restricted or limited by the structure and position of the alignment protrusion 330.

For example, the alignment protrusion 330 may have an approximately straight rod shape and protrude from an edge portion (e.g., two or more edge portions) of the sealing part 300. The alignment groove 270, which corresponds to the alignment protrusion 330, may be provided in an edge portion of the separator 200.

As described above, in an embodiment of the present disclosure, the alignment protrusion 330 connected to the sealing part 300 can be accommodated in the alignment groove 270 provided in the separator 200. Therefore, in an embodiment of the present disclosure, it can be possible to obtain an advantageous effect of minimizing the misalignment of the sealing part 300 with respect to the separator 200 when the sealing part 300 is seated on the separator 200. In an embodiment of the present disclosure, it can be possible to obtain an advantageous effect of more stably maintaining the state in which the sealing part 300 is seated on the separator 200.

According to an example embodiment of the present disclosure, the electrochemical device may include a first alignment hole 340 provided in the alignment protrusion 330, and a second alignment hole 280 provided in the separator 200 while corresponding to the first alignment hole 340.

The first alignment hole 340 and the second alignment hole 280 may have various structures through which an alignment rod (not illustrated) may pass. An embodiment of the present disclosure is not necessarily restricted or limited by the structures and shapes of the first alignment hole 340 and the second alignment hole 280.

For example, the first alignment hole 340 and the second alignment hole 280 may each have a circular hole shape. According to an embodiment of the present disclosure, the first alignment hole and the second alignment hole may each have a quadrangular hole or other shapes.

As described above, in an embodiment of the present disclosure, the first alignment hole 340 and the second alignment hole 280 can be respectively provided in the alignment protrusion 330 and the separator 200, and the separator 200 and the sealing part 300 can be stacked in a state in which the alignment rod is fitted into the first alignment hole 340 and the second alignment hole 280, such that the misalignment of the sealing part 300 with respect to the separator 200 may be prevented, and the process of aligning the separator 200 and the sealing part 300 may be simplified. Therefore, in an embodiment of the present disclosure, it can be possible to obtain an advantageous effect of improving the productivity and reducing the amount of time required for the process of assembling the separator 200 and the sealing part 300.

While example embodiments have been described above, the example embodiments are just illustrative and not intended to necessarily limit the present disclosure. It can be appreciated by those skilled in the art that various modifications and applications, which are not described above, may be made to the present embodiment without departing from intrinsic features of a potential embodiment. For example, respective constituent elements specifically described in the example embodiments may be modified and then carried out. Further, it can be interpreted that the differences related to the modifications and applications can be included in scopes of the present disclosure defined by the appended claims.

What is claimed is:

1. An electrochemical device comprising:
a membrane electrode assembly (MEA);
a separator stacked on the membrane electrode assembly and comprising a flow path portion provided to face the membrane electrode assembly, a manifold portion through which a reaction fluid can be introduced or discharged, and a through-hole provided between the flow path portion and the manifold portion and configured to guide the reaction fluid that has passed through the manifold portion to the flow path portion; and
a sealing part selectively separably stacked on the separator and configured to define a connection channel configured to connect the manifold portion and the flow path portion through the through-hole, wherein the sealing part comprises:
a first elastic sheet,
a second elastic sheet stacked on the first elastic sheet, and
a reinforcement sheet having relatively higher rigidity than the first elastic sheet and the second elastic sheet and interposed between the first elastic sheet and the second elastic sheet.

2. The electrochemical device of claim 1, wherein the reinforcement sheet comprises:
a main sheet body interposed between the first elastic sheet and the second elastic sheet; and
sheet protrusions provided on two opposite surfaces of the main sheet body and configured to support the first elastic sheet and the second elastic sheet in a state in which the first elastic sheet and the second elastic sheet are spaced apart from the main sheet body.

3. The electrochemical device of claim 1, comprising:
a stopper portion provided on the separator and configured to restrict a horizontal movement of the sealing part relative to the separator.

4. The electrochemical device of claim 3, wherein the stopper portion comprises:
a first stopper protrusion configured to support a first side surface of the sealing part; and
a second stopper protrusion provided to face the first stopper protrusion and configured to support a second side surface of the sealing part.

5. The electrochemical device of claim 1, wherein the sealing part comprises:
a first sealing member provided on a first surface of the separator and configured to define a first connection channel configured to connect the manifold portion and the through-hole; and
a second sealing member provided on a second surface of the separator, which faces the membrane electrode assembly, and configured to define a second connection channel configured to connect the through-hole and the flow path portion, wherein the first connection channel and the second connection channel collectively define the connection channel.

6. The electrochemical device of claim 5, wherein the first sealing member comprises:
a first-first body sealing portion provided along an edge of the separator;
a first-second body sealing portion provided to surround the manifold portion and the through-hole and connected to the first-first body sealing portion; and
a plurality of first guide sealing portions connected to the first-second body sealing portion and configured to define the first connection channel.

7. The electrochemical device of claim 6, further comprising a first connection sealing portion configured to continuously connect ends of the first guide sealing portions adjacent to the manifold portion.

8. The electrochemical device of claim 7, further comprising a support rib extending from the separator and configured to support the first connection sealing portion on the separator.

9. The electrochemical device of claim 5, wherein the second sealing member comprises:
a second-first body sealing portion provided along an edge of the separator;
a second-second body sealing portion provided to surround the manifold portion and connected to the second-first body sealing portion; and
a plurality of second guide sealing portions connected to the second-second body sealing portion and configured to define the second connection channel.

10. The electrochemical device of claim 9, further comprising a second connection sealing portion configured to continuously connect ends of the second guide sealing portions adjacent to the flow path portion.

11. The electrochemical device of claim 10, further comprising an extension flow path provided on the separator so that a first end of the extension flow path communicates with the second connection channel, and a second end of the extension flow path communicates with the flow path portion,
wherein the second connection sealing portion is configured to partially cover the extension flow path.

12. The electrochemical device of claim 1, further comprising:
an alignment protrusion connected to the sealing part; and
an alignment groove in the separator and configured to accommodate the alignment protrusion.

13. The electrochemical device of claim 12, further comprising:
a first alignment hole in the alignment protrusion; and
a second alignment hole in the separator and configured to align with the first alignment hole.

14. An electrochemical device comprising:
a membrane electrode assembly (MEA);
a separator stacked on the membrane electrode assembly and comprising a flow path portion provided to face the membrane electrode assembly, a manifold portion through which a reaction fluid can be introduced or discharged, and a through-hole provided between the flow path portion and the manifold portion and configured to guide the reaction fluid, which has passed through the manifold portion, to the flow path portion;
support ribs extending from the separator and protruding toward an inside of the manifold portion;
a through-portion defined between adjacent support ribs of the support ribs; and
a sealing part comprising:
a first sealing member provided on a first surface of the separator and configured to define a first connection channel configured to connect the manifold portion and the through-hole, and
a second sealing member provided on a second surface of the separator, which faces the membrane electrode assembly, and configured to define a second connection channel configured to connect the through-hole and the flow path portion,
wherein an inlet end of the first connection channel is configured to communicate with the through-portion in a thickness direction of the separator.

15. The electrochemical device of claim 14, wherein the first sealing member comprises:
a first-first body sealing portion provided along an edge of the separator;
a first-second body sealing portion provided to surround the manifold portion and the through-hole and connected to the first-first body sealing portion;
a plurality of first guide sealing portions connected to the first-second body sealing portion and configured to define the first connection channel; and
a first connection sealing portion configured to continuously connect ends of the first guide sealing portions adjacent to the manifold portion, the first connection sealing portion being supported on the support ribs and configured to partially cover a part of the through-portion, and configured such that
the reaction fluid introduced into the manifold portion can flow along the first connection channel, which is provided on the first surface of the separator, through the through-portion on the second surface of the separator.

16. The electrochemical device of claim 14, wherein the second sealing member comprises:
a second-first body sealing portion provided along an edge of the separator;
a second-second body sealing portion provided to surround the manifold portion and connected to the second-first body sealing portion; and
a plurality of second guide sealing portions connected to the second-second body sealing portion and configured to define the second connection channel.

17. The electrochemical device of claim 16, further comprising a second connection sealing portion configured to continuously connect ends of the second guide sealing portions adjacent to the flow path portion.

18. The electrochemical device of claim 17, further comprising an extension flow path provided on the separator so that a first end of the extension flow path communicates with the second connection channel, and a second end of the extension flow path communicates with the flow path portion, wherein the second connection sealing portion is configured to partially cover the extension flow path.

19. The electrochemical device of claim 14, wherein the sealing part comprises:
a first elastic sheet;
a second elastic sheet stacked on the first elastic sheet; and
a reinforcement sheet having relatively higher rigidity than the first elastic sheet and the second elastic sheet and interposed between the first elastic sheet and the second elastic sheet.

20. The electrochemical device of claim 19, wherein the reinforcement sheet comprises:
a main sheet body interposed between the first elastic sheet and the second elastic sheet; and
sheet protrusions provided on two opposite surfaces of the main sheet body and configured to support the first elastic sheet and the second elastic sheet in a state in which the first elastic sheet and the second elastic sheet are spaced apart from the main sheet body.

21. The electrochemical device of claim 14, further comprising a stopper portion provided on the separator and configured to restrict a horizontal movement of the sealing part relative to the separator.

22. The electrochemical device of claim 21, wherein the stopper portion comprises:
a first stopper protrusion configured to support a first side surface of the sealing part; and
a second stopper protrusion provided to face the first stopper protrusion and configured to support a second side surface of the sealing part.

23. The electrochemical device of claim 14, further comprising:
an alignment protrusion connected to the sealing part; and
an alignment groove in the separator and configured to accommodate the alignment protrusion.

24. The electrochemical device of claim 23, further comprising:
a first alignment hole in the alignment protrusion; and
a second alignment hole in the separator and configured to align with the first alignment hole.
